(19) United States
(12) Patent Application Publication
(10) Pub. No.: US 2016/0281871 A1
(43) Pub. Date: Sep. 29, 2016

(54) PRESSURE REGULATING VALVE

(71) Applicant: AISAN KOGYO KABUSHIKI KAISHA, Obu-shi (JP)

(72) Inventors: Masahiro KOBAYASHI, Toyohashi-shi (JP); Hideyuki FUKUDA, Nagoya-shi (JP); Katsuyuki HATA, Nagoya-shi (JP); Kazuhiro NAKAMURA, Ichinomiya-shi (JP)

(73) Assignee: AISAN KOGYO KABUSHIKI KAISHA, Obu-shi (JP)

(21) Appl. No.: 15/070,255

(22) Filed: Mar. 15, 2016

(30) Foreign Application Priority Data
Mar. 26, 2015 (JP) 2015-063741

(51) Int. Cl. F16K 17/12; F16K 1/14

(52) U.S. Cl. CPC F16K 17/12; F16K 1/14

(57) ABSTRACT

A pressure regulating valve includes a valve element placed in a valve chamber, a piston placed in a pressure regulating chamber, a valve seat that partitions between the valve chamber and the pressure regulating chamber, and a valve spring that urges the valve element toward the valve seat. The piston is placed in a position toward which the valve spring urges the valve element. The pressure regulating valve further includes a terminal block provided with the valve chamber and a body member provided with the pressure regulating chamber. The valve seat is held in close contact relation between the terminal block and the body member.

### CROSS-REFERENCE TO RELATED APPLICATIONS

This application is based upon and claims the benefit of priority from the prior Japanese Patent Application No. 2015-063741, filed Mar. 26, 2015, the entire contents of which are incorporated herein by reference.

### BACKGROUND OF THE INVENTION

1. Field of the Invention

The present invention relates to a pressure regulating valve for regulating the pressure of a high-pressure primary fluid to a desired pressure by reducing the pressure and particularly to a pressure regulating valve to be used in a supply circuit of vehicle fuel gas.

2. Related Art

As a conventional art, there is a regulator disclosed in Patent document 1. The regulator disclosed in Patent document 1 includes a pressure regulating valve placed in a valve accommodating hole, a piston placed in a pressure regulating chamber, a valve seat partitioning between the valve accommodating hole and the pressure regulating chamber, and a valve spring that urges the pressure regulating valve toward the valve seat. The piston is placed in a position toward which the valve spring urges the pressure regulating valve.

### RELATED ART DOCUMENTS

### Patent Documents

Patent document 1: Japanese unexamined patent application publication No. 2012-73886

### Problems to be Solved by the Invention

In the regulator disclosed in Patent document 1 listed above, for the purpose of hermetically closing the valve accommodating hole and the pressure regulating chamber, sealing members are individually provided between a base body and a cylindrical body, between the piston and the cylindrical body, between the valve seat and the base body, and others. However, from the view point of manufacturing cost and workability in manufacture, it is desired to reduce the number of components to the minimum and simplify the regulator structure.

The present invention has been made to solve the above-mentioned problems and has a purpose to provide a pressure regulating valve with a simplified structure.

### Means of Solving the Problems

To achieve the above purpose, one aspect of the invention provides a pressure regulating valve including a valve chamber and a pressure regulating chamber, the pressure regulating valve comprising: a valve element placed in the valve chamber; a piston placed in the pressure regulating chamber; a valve seat member that partitions between the valve chamber and the pressure regulating chamber; and an urging member that urges the valve element toward the valve seat member, the piston being placed in a position toward which the urging member urges the valve element, wherein the pressure regulating valve further comprises: an inlet member provided with the valve chamber; and a body member provided with the pressure regulating chamber, and the valve seat member is held in close contact relation between the inlet member and the body member.

According to the present aspect, the valve seat member can seal between the inlet member and the body member. Thus, there is no need to place any additional sealing member other than the valve seat member. This can reduce the number of components, thereby enabling to simplify the structure of the pressure regulating valve.

### Effects of the Invention

The pressure regulating valve according to the pressure regulating valve can provide a simplified structure.

### BRIEF DESCRIPTION OF THE DRAWINGS

FIG. 1 is a sectional view of a whole pressure regulating valve in an embodiment of the present invention;

FIG. 2 is an enlarged sectional view of a valve seat and its surroundings; and

FIG. 3 is a sectional view taken along a line A-A in FIG. 2.

### DESCRIPTION OF EMBODIMENTS

A detailed description of a preferred embodiment of a pressure regulating valve embodying the present invention will now be given referring to the accompanying drawings. A whole structure of the pressure regulating valve and its operating method in the present embodiment will be first explained. Further, a structure and operations of a valve seat and its surroundings in an upstream pressure regulating valve of the pressure regulating valve in the present embodiment will be then described.

<Whole Structure of Pressure Regulating Valve>

Firstly, the whole structure of the pressure regulating valve in the present embodiment will be explained below.

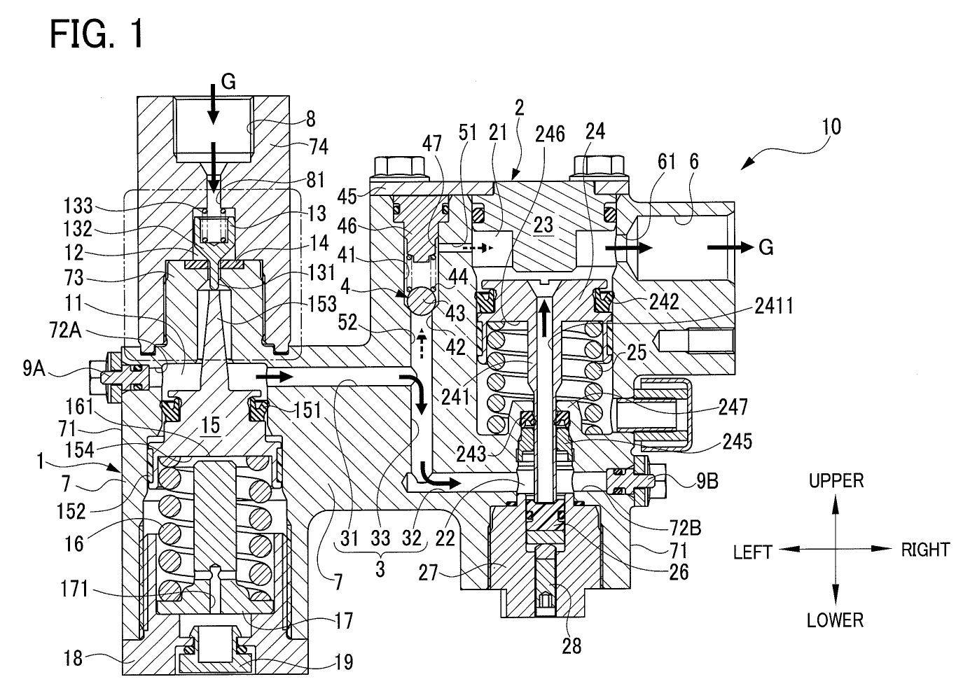

As shown in FIG. 1, the pressure regulating valve 10 in the present embodiment is a multistage pressure regulating valve configured to regulate or adjust the pressure of fuel gas G to a desired value by reducing this fuel gas pressure in multiple stages. The pressure regulating valve 10 includes a body member 7 provided therein with an upstream pressure regulating valve 1 located on an upstream side in a flow direction of the fuel gas G, a downstream pressure regulating valve 2 located on a downstream side, an intermediate passage 3 through which the fuel gas G will flow after pressure-reduced by the upstream pressure regulating valve 1 but before pressure-reduced by the downstream pressure regulating valve 2, and a check valve 4 connected to the intermediate passage 3. The body member 7 of the pressure regulating valve 10 is made of aluminum alloy and is formed internally with the upstream pressure regulating valve 1, the downstream pressure regulating valve 2, the intermediate passage 3, the check valve 4, and others. The upstream pressure regulating valve 1 and the downstream pressure regulating valve 2 are connected in serial to each other.

The fuel gas G is for example hydrogen gas to be supplied to a vehicle fuel cell (FC). An upstream side of the pressure regulating valve 10 is connected to a main stop valve operative to supply or stop the fuel gas G stored in a fuel tank and a downstream side of the pressure regulating valve 10 is connected to an injector for supplying the fuel gas G having been regulated to the desired pressure to the fuel cell (not shown). The fuel gas G stored in the fuel tank may be filled under pressure of about 80 to 90 MPa according to a filling facility. On the other hand, the pressure of the fuel gas G to be supplied from the pressure regulating valve 10 to the injector is reduced to a pressure of about 1.0 to 1.5 MPa. Accordingly, the pressure regulating valve 10 reduces the pressure of the fuel gas G from about 80 to 90 MPa to about 3.0 to 2.5 MPa in the upstream pressure regulating valve 1 and then from about 3.0 to 2.5 MPa to about 1.0 to 1.5 MPa in the downstream pressure regulating valve 2.

A left upper end of the body member 7 in FIG. 1 is formed with a cylindrical protruding part 73 protruding upward. This protruding part 73 is connected with a hexagonal terminal block 74 threadedly engaged thereon from above. The terminal block 74 is formed with an inlet terminal 8 opening upward to be connected with the main stop valve. A right upper end of the body member 7 is formed with an outlet terminal 6 opening rightward to be connected with the injector.

(Upstream Pressure Regulating Valve)

The upstream pressure regulating valve 1 includes a valve chamber 12 communicated with the inlet terminal 8, a valve element 13 movable up and down in the valve chamber 12, a valve seat (a valve seat member) 14 formed at a lower end of the valve chamber 12 so that the valve element 13 will be brought into contact with and separated from the valve seat 14, a pressure regulating chamber 11 located below the valve seat 14 and allowed to communicate with the valve chamber 12 when the valve element 13 is moved upward, a piston 15 movable up and down in the pressure regulating chamber 11, a coil spring 16 urging the piston 15 upward, a holder member 17 receiving a lower end of the coil spring 16 to hold the coil spring 16, and a stopper member 18. The piston 15 is placed in a position toward which a valve spring 133 urges the valve element 13.

The terminal block 74 is internally formed with an inlet terminal passage 81 vertically extending to provide communication between the inlet terminal 8 and the valve chamber 12. Between a wall surface defining the valve chamber 12 and the valve element 13, the valve spring 133 (an urging member) is interposed to urge the valve element 13 downward (toward the valve seat 14). The valve element 13 includes a main body portion 134 in which one end of the valve spring 133 is mounted and a tapered portion 132 continuous to a lower end of the main body portion 134. This tapered portion 132 will be brought into contact with and separated from the valve seat 14. Under the tapered portion 132, a needle portion 131 is formed. This needle portion 131 penetrates through a through hole 340 formed in the valve seat 14 and extends into the pressure regulating chamber 11. A lower end of the needle portion 131 abuts on a top face 360 of an axially protruding portion 153 having a rod-like shape protruding from an upper end of a main portion of the piston 15.

On an outer peripheral surface of the main portion of the piston 15, there is fitted an annular sealing member 151 held in sliding contact with an inner peripheral surface of the pressure regulating chamber 11 to seal the pressure regulating chamber 11. This annular sealing member 151 has a lip-shaped cross-section opening upward in a V shape. A lower end of the piston 15 is formed with a spring receiving seat 154 recessed to hold the coil spring 16. The spring receiving seat 154 has a horizontal surface on which a coil end (an upper end) 161 of the coil spring 16 abuts. On an outer peripheral wall of the spring receiving seat 154, a sliding member 152 made of fluorine contained resin is mounted. The holder member 17 contacting with the lower end of the coil spring 16 is formed with a vent hole 171. The stopper member 18 is provided with a filter member 19 for filtering the outside air to be drawn into a cavity provided under the piston 15 through the vent hole 171. The pressure regulating chamber 11 is communicated with a valve chamber 22 of the downstream pressure regulating valve 2 through the intermediate passage 3 (31, 32, and 33) as described later.

(Downstream Pressure Regulating Valve)

The downstream pressure regulating valve 2 is provided with a pressure regulating chamber 21 communicated with the outlet terminal 6, a piston 24 movable up and down in the pressure regulating chamber 21, a coil spring 25 urging the piston 24 upward, the valve chamber 22 formed below the pressure regulating chamber 21, a nearly cylindrical valve element 241 extending in an axial direction of the piston 24 into the valve chamber 22, a valve seat 26 provided in a lower end of the valve chamber 22 so that a lower end of the valve element 241 will be brought into contact with and separated from the valve seat 26, a stopper member 27 having the valve seat 26 fitted therein and being threadedly engaged in a right lower end of the body member 7, and an adjusting screw 28 threadedly engaged in the stopper member 27 to allow adjustment of the height of the valve seat 26.

The pressure regulating chamber 21 is sealingly closed by a lid member 23 fitted from above in a right upper end portion of the body member 7. The lid member 23 is formed with a columnar protrusion axially extending downward to restrict upward movement of the piston 24 when an upper end of the piston 24 comes into contact with the relevant protrusion. When the upper end of the piston 24 contacts with this protrusion, an annular space is generated in the pressure regulating chamber 21. An outlet terminal passage 61 is formed horizontally to communicate the pressure regulating chamber 21 with the outlet terminal 6.

A columnar-shaped through hole 2411 is formed through the piston 24 and the valve element 241 in their axial direction to extend from the upper end of the piston 24 to a lower end of the valve element 241. On an outer peripheral surface of a main portion of the piston 24, there is fitted an annular sealing member 242 held in sliding contact with an inner peripheral surface defining the pressure regulating chamber 21 to seal the pressure regulating chamber 21. The annular sealing member 242 has a lip-shaped cross-section opening upward in a V shape. A lower end of the piston 24 is formed with a spring receiving seat 246 recessed to hold an upper end of the coil spring 25. The coil spring 25 is a cylindrical compression spring. A lower end of the coil spring 25 is restricted in position by a holding portion 247 integrally formed with the body member 7.

Under the holding portion 247, an annular sealing member 243 is fitted in sliding contact with an outer peripheral surface of the valve element 241 to seal the valve chamber 22. The annular sealing member 243 has a lip-shaped cross-section opening downward in a V shape (toward the valve chamber). Under the annular sealing member 243, a bearing portion 245 is installed to support the valve element 24 so that the valve element 24 is axially movable up and down. The bearing portion 245 also serves as a stopper to prevent dropping of the annular sealing member 243. The valve chamber 22 is formed in a nearly cylindrical shape under the bearing 245.

(Intermediate Passage)

The intermediate passage 3 includes a first intermediate passage 31 extending horizontally from the pressure regulating chamber 11 of the upstream pressure regulating valve 1, a second intermediate passage 32 extending horizontally from the valve chamber 22 of the downstream pressure regulating valve 2, and a third intermediate passage 33 extending vertically to communicate the first intermediate passage 31 with the second intermediate passage 32. The body member 7 is formed with a hole 72A used in machining the first intermediate passage 31, and a hole 72B used in machining the second intermediate passage 32. To an outer wall surface 71 of the body member 7, sealing members 9A and 9B are respectively secured to hermetically seal the holes 72A and 72B. Above the third intermediate passage 33, there is provided the check valve 4 mentioned later. Between an entrance 42 of the check valve 4 and the third intermediate passage 33, a check-valve entrance passage 52 is formed to extend vertically to communicate the third intermediate passage 33 with the entrance 42.

(Check Valve)

The check valve 4 is an inward flow check valve and is provided with a valve chamber 41, the entrance 42 of the valve chamber 41, a ball valve 43 accommodated in the valve chamber 41 and moved into contact with or away from the entrance 42, a press spring 44 urging the ball valve 43 toward the entrance 42, a sealing member 46 holding the press spring 44 and sealing the valve chamber 41 with respect to the body member 7, and an exit 47 of the valve chamber 41. Between the exit 47 and the pressure regulating chamber 21 of the downstream pressure regulating valve 2, there is formed a check-valve exit passage 51 extending horizontally to communicate the exit 47 with the pressure regulating chamber 21. The exit passage 51 is formed coaxially with the outlet terminal passage 61.

<Operating Method of Pressure Regulating Valve>

Next, an operating method of the pressure regulating valve according to the present embodiment will be explained with reference to FIG. 1.

As shown in FIG. 1, for example, when fuel gas G starts to be supplied to a vehicle fuel cell and flow out from the outlet terminal 6 in a direction indicated by arrows, the pressure of fuel gas G stored in the pressure regulating chamber 21 of the downstream pressure regulating valve 2 lowers. As the pressure of fuel gas G in the pressure regulating chamber 21 decreases, the piston 24 moves upward, allowing supply of the fuel gas G from the valve chamber 22 to the pressure regulating chamber 21 via the piston through hole 2411 formed in the piston 24 and the valve element 241. This increases the internal pressure of the pressure regulating chamber 21. When the internal pressure of the pressure regulating chamber 21 reaches a predetermined pressure, the piston 24 presses downward the spring 25, bringing the lower end of the valve element 241 into contact with the valve seat 26, thus stopping supply of the fuel gas G from the valve chamber 22. The internal pressure of the pressure regulating chamber 21 can be set to a desired value (a final pressure) by adjusting a screwing amount of the adjusting screw 28 in the stopper member 27.

Since the valve chamber 22 of the downstream pressure regulating valve 2 and the pressure regulating chamber 11 of the upstream pressure regulating valve 1 are communicated with each other through the intermediate passages 3 (31, 32, and 33), when the pressure of fuel gas G in the valve chamber 22 lowers, the fuel gas G stored in the pressure regulating chamber 11 of the upstream pressure regulating valve 1 is allowed to flow in a direction of arrows as shown in FIG. 1 to increase the internal pressure of the valve chamber 22 of the downstream pressure regulating valve 2. At that time, the internal pressure of the pressure regulating chamber 11 of the upstream pressure regulating valve 1 is decreased, and thereby the valve element 13 of the upstream pressure regulating valve 1 is moved upward by the urging force of the coil spring 16 urging the piston 15. When the valve element 13 is moved upward and separated from the valve seat 14, the high-pressure fuel gas G supplied from a fuel tank to the inlet terminal 8 is allowed to flow in the pressure regulating chamber 11 via the inlet terminal passage 81 and the valve chamber 12. Accordingly, the pressure of the fuel gas G in the pressure regulating chamber 11 is maintained at a predetermined value (an intermediate pressure).

Herein, when supply of the fuel gas G to the fuel cell is stopped, the pressure of the fuel gas G stored in the pressure regulating chamber 21 of the downstream pressure regulating valve 2 is no longer decreased. Thus, the fuel gas G leaking from the upstream pressure regulating valve 1 into the intermediate passages 3 (31, 32, and 33) does not escape to anywhere, resulting in an increase in internal pressure of the intermediate passages 3. When the pressure of the fuel gas G in the intermediate passages 3 rises to or more than a predetermined value, the ball valve 43 of the check valve 4 moves away from the entrance 42 and thus the check valve 4 operates. At that time, the fuel gas G is released from the third intermediate passage 33 into the valve chamber 41 of the check valve 4 through the check-valve entrance passage 52. This makes it possible to avoid overload of the fuel gas G on the annular sealing member 151 sealing the pressure regulating chamber 11 of the upstream pressure regulating valve 1 and the annular sealing member 243 sealing the valve chamber 22 of the downstream pressure regulating valve 2, the chambers 11 and 22 being continuous with the intermediate passages 3 (31, 32, and 33). The fuel gas G released into the valve chamber 41 of the check valve 4 is then supplied to the outlet terminal 6 through the pressure regulating chamber 21 of the downstream pressure regulating valve 2 and the outlet terminal passage 61. This can reduce waste of the fuel gas G due to outside release.

<Explanation of Valve Seat and Surrounding Parts>

Next, the valve seat 14 and its surrounding configuration that partition between the valve chamber 12 and the pressure regulating chamber 11 will be explained. The valve seat 14 is one example of a “valve seat member” of the present invention.

The cylindrical protruding part 73 is a part of the body member 7. This protruding part 73 has a cylindrical shape having an inner wall surface 300 (an inner peripheral surface) defining a part of the pressure regulating chamber 11. Further, the protruding part 73 is formed, on its peripheral surface 302, with male threads 304. The protruding part 73 is further formed, on its top face 306, with a recessed portion 308. This recessed portion 308 is a portion recessed from the top face 306 toward the pressure regulating chamber 11.

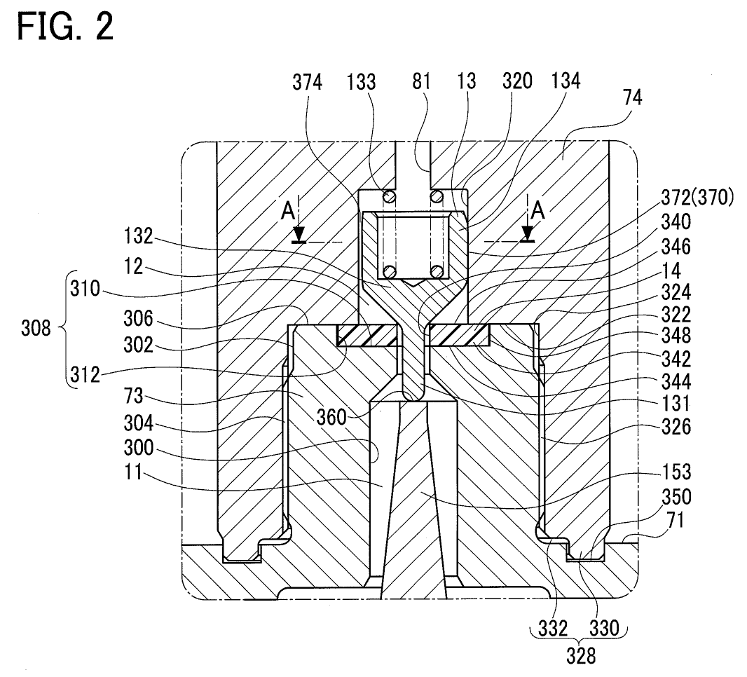

The terminal block 74 has a hexagonal outer shape and an inner wall surface 320 (an inner peripheral surface) defining the valve chamber 12. Specifically, the valve chamber 12 is formed by the inner wall surface 320. The terminal block 74 is provided with a shoulder surface 322 extending in a radiation direction of the terminal block 74 (a right-left direction in FIGS. 1 and 2) from an exit of the valve chamber 12 located opposite to the inlet terminal passage 81. The terminal block 74 further includes a side surface 324 extending in an axial direction of the terminal block 74 from an outer peripheral edge of the shoulder surface 322. This side surface 324 is formed with female threads 326. The terminal block 74 is one example of an “inlet member” of the present invention. The material of the terminal block 74 is for example stainless steel.

The valve seat 14 has a hollow disc-like shape having a through hole 340 at the center. This valve seat 14 is made of resin (e.g., polyimide). In the present embodiment, the valve seat 14 is fixedly sandwiched in close contact relation between the cylindrical protruding part 73 and the terminal block 74. To be more concrete, an outer peripheral edge portion 342 of the valve seat 14 in a radial direction thereof is closely held between a bottom surface 310 of the recessed portion 308 of the protruding part 73 and the shoulder surface 322 of the terminal block 74. Still more concretely, a radially outer peripheral edge portion of one end face 344 of the valve seat 14 in the axial direction closely contacts with the bottom surface 310 of the recessed portion 308, and, a radially outer peripheral edge portion of the other end face 346 of the valve seat 14 in the axial direction closely contacts with the shoulder surface 322 of the terminal block 74. In the present embodiment, an outer peripheral surface 348 of the valve seat 14 is in contact with a side surface 312 of the recessed portion 308.

The body member 7 includes a recess 350 located near a root portion of the cylindrical protruding part 73 and recessed from an outer wall surface 71 of the body member 7. This recess 350 is formed to extend by one circumference around the protruding part 73 in the vicinity of the root portion thereof. Correspondingly, the terminal block 74 is provided with a protrusion 330 in a leading end portion (a lower end portion in the figures) 328 (an “inlet-member leading end portion”) contacting with the body member 7. This protrusion 330 is formed over one circumference of the terminal block 74 in a circumferential direction. The protrusion 330 protrudes from the end face 332 of the terminal block 74 facing the body member 7 in the axial direction toward the body member 7. The thus configured protrusion 330 of the terminal block 74 is inserted in the recess 350 of the body member 7. In this manner, the protrusion 330 and the recess 350 are fitted with each other. An alternative may be arranged such that the terminal block 74 is provided with a recess and the body member 7 is provided with a protrusion, these protrusion and recess are fitted with each other. In the present embodiment, the body member 7 is made of material (e.g., aluminum) having lower pressure resistance than the terminal block 74.

A leading end face 360 of the axially protruding portion 153 of the piston 15 placed in the pressure regulating chamber 11 contacts with the valve element 13 placed extending from the valve chamber 12 into the pressure regulating chamber 11. The axially protruding portion 153 in the present embodiment is formed to be thinner, i.e., to have a diameter decreasing toward the leading end face 360. The valve element 13 is one example of a “valve” of the present invention. The valve element 13 is configured such that the needle portion 131 has a columnar shape, the tapered portion 132 has a conical shape, and the main body portion 134 has a cylindrical shape.

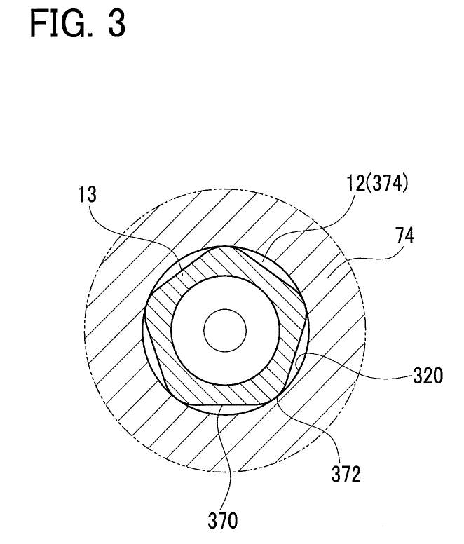

In a cross-section (taken along a line A-A in FIG. 2) of the valve chamber 12 in a direction (the right-left direction in FIGS. 1 and 2) perpendicular to the axial direction (the upper-lower direction in FIGS. 1 and 2) of the valve chamber 12, as shown in FIG. 3, the inner wall surface 320 of the terminal block 74 defining the valve chamber 12 has a circular cross-section, while the outer peripheral surface 370 of the valve element 13 has a pentagonal cross-section including curved (e.g., circular-arc) corner portions 372.

The valve element 13 can be moved in the axial direction of the valve chamber 12 while the corner portions 372 of the valve element 13 slide along the inner wall surface 320 of the terminal block 74. Thus, flow passages 374 are formed each between adjacent two of corner portions 372 in the circumferential direction of the valve element 13. Specifically, each flow passage 374 is formed in a gap between the inner wall surface 320 of the terminal block 74 and the outer peripheral surface 370 of the valve element 13. In an example shown in FIG. 3, total five passages 374 are formed by the corner portions 372 in the circumferential direction of the valve element 13. In FIG. 3, the valve spring 133 is omitted for convenience of explanation.

The cross-sectional shape of the inner wall surface 320 in FIG. 3 is not particularly limited to a circular shape and may be a nearly circular shape. The cross-sectional shape of the outer peripheral surface 370 of the valve element 13 in FIG. 3 is not particularly to a pentagonal shape and may be an even polygonal shape or an odd polygonal shape such as a triangular shape. As an alternative, further, in FIG. 3, it may be arranged such that the inner wall surface 320 has an odd polygonal cross-section or an even polygonal cross-section and the outer peripheral surface 370 of the valve element 13 has a circular or nearly circular cross-section.

The pressure regulating valve 10 in the present embodiment includes, as described above, the terminal block 74 provided with the valve chamber 12, and the body member 7 provided with the pressure regulating chamber 11. The valve seat 14 partitioning between the pressure regulating chamber 11 and the valve chamber 12 is sandwiched in close contact relation between the terminal block 74 and the cylindrical protruding part 73 of the body member 7.

Accordingly, the valve seat 14 is fixedly held in close contact relation between the terminal block 74 and the cylindrical protruding part 73 of the body member 7. Thus, the valve seat 14 functions to seal between the terminal block 74 and the protruding part 73 (to be concrete, between the shoulder surface 322 of the terminal block 74 and the bottom surface 310 of the recessed portion 308 of the protruding part 73).

Herein, the sealing function of the valve seat 14 concretely includes a function of shutting off a communication between the pressure regulating chamber 11 and the valve chamber 12 during closing of the valve element 13 and a function of sealing the inside of the pressure regulating chamber 11 and the inside of the valve chamber 12 from outside of the pressure regulating valve 10. Since the valve seat 14 serves those functions, there is no need to additionally provide any sealing member such as an O ring, for example, between the pressure regulating chamber 11 and the valve chamber 12 and between the cylindrical protruding part 73 and the terminal block 74. Therefore, the valve seat 14 can serve the sealing function which is conventionally carried out by a plurality of sealing members.

According to the pressure regulating valve 10 in the present embodiment, therefore, the number of components can be reduced. This can simplify the structure of the pressure regulating valve 10 (concretely, the structure of the terminal block 74 and the cylindrical protruding part 73, and their surrounding configurations, in the upstream pressure regulating valve 1). Thus, the pressure regulating valve 10 can be manufactured at reduced cost and further produced with improved workability.

In the present embodiment, the protrusion 330 formed in the leading end portion 328 of the terminal block 74 and the recess 350 formed in the body member 7 are engaged with each other. This provides a mating configuration between the terminal block 74 and the body member 7. This configuration enables appropriately positioning the terminal block 74 and the cylindrical protruding part 73 of the body member 7 while suppressing the influence of backlash in a screw section including the male threads 304 and the female threads 326. Thus, the degree of axial coincidence between the terminal block 74 and the protruding part 73 of the body member 7 is improved, so that an eccentric amount of the valve element 13 with respect to the central axis of the protruding part 73 is small. Accordingly, the inclination of the piston 15 with respect to the central axis of the protruding part 73 (that is, the central axis of the pressure regulating chamber 11 in the protruding part 73) can be reduced and hence the sliding resistance of each of the annular sealing member 151 of the piston 15 and the sliding member 152 can be also reduced. Moreover, the contact performance of the valve seat 14 with the bottom surface 310 of the recessed portion 308 of the protruding part 73 and the contact performance of the valve seat 14 with the shoulder surface 322 of the terminal block 74 can be enhanced. This results in improved sealing function of the valve seat 14.

In the present embodiment, the axially protruding portion 153 of the piston 15 is formed to be gradually thinner with a diameter decreasing toward the leading end face 360. Even if the central axis of the piston 15 is inclined with respect to the central axis of the pressure regulating chamber 11 in the cylindrical protruding part 73, consequently, the piston 15 can be prevented from interfering with the inner wall surface 300 of the protruding part 73 of the body member 7.

In the present embodiment, as shown in FIG. 3 corresponding to the A-A cross-section in FIG. 2, the inner wall surface 320 has a circular shape and the outer peripheral surface 370 of the valve element 13 has a pentagonal shape. Therefore, the outer peripheral surface 370 of the valve element 13 does not include any faces symmetrically located with respect to the central axis of the valve element 13. Accordingly, even if the central axis of the valve element 13 is inclined with respect to the central axis of the valve chamber 12 by the action of high pressure on the valve element 13 from the inlet terminal passage 81, for example, any of the corner portions 372 of the outer peripheral surface 370 of the valve element 13 will contact with the inner wall surface 320. This can reduce the possible inclination angle of the central axis of the valve element 13 with respect to the central axis of the valve chamber 12. Thus, an eccentric amount of load acting on the piston 15 from the valve element 13 is reduced. Since the inclination of the piston 15 with respect to the central axis of the protruding part 73 can be reduced, consequently, the sliding resistance in the annular sealing member 151 and the sliding member 152 of the piston 15 can be reduced.

In the present embodiment, the body member 7 is made of material having lower pressure resistance than the terminal block 74. Accordingly, there is no need to make the whole pressure regulating valve 10 of excessive high-pressure resistance material. Cost reduction can thus be achieved.

The foregoing embodiment is a mere example and does not give any limitations to the present invention. The present embodiment may be embodied in other specific forms without departing from the essential characteristics thereof.

### REFERENCE SIGNS LIST

1 Upstream pressure regulating valve
2 Downstream pressure regulating valve
3 Intermediate passage
4 Check valve
7 Body member
10 Pressure regulating valve
11 Pressure regulating chamber
12 Valve chamber
13 Valve element
14 Valve seat
15 Piston
71 Outer wall surface
73 Cylindrical protrusion
81 Inlet terminal passage
131 Needle portion
132 Tapered portion
133 Valve spring
134 Main body portion
153 Axially protruding portion
300 Inner wall surface
302 Side surface
304 Male threads
306 Top face
308 Recessed portion
310 Bottom surface
320 Inner wall surface
322 Shoulder Surface
324 Side surface
326 Female threads
330 Protruding portion
340 Through hole
342 Edge portion
344 End face
346 End face
350 Recess
360 Leading end face
370 Outer peripheral surface
372 Corner portion
374 Flow passage
G Fuel gas

What is claimed is:

1. A pressure regulating valve including a valve chamber and a pressure regulating chamber, the pressure regulating valve comprising:
a valve element placed in the valve chamber;
a piston placed in the pressure regulating chamber;
a valve seat member that partitions between the valve chamber and the pressure regulating chamber; and
an urging member that urges the valve element toward the valve seat member,
the piston being placed in a position toward which the urging member urges the valve element,
wherein the pressure regulating valve further comprises:
an inlet member provided with the valve chamber; and
a body member provided with the pressure regulating chamber, and
the valve seat member is held in close contact relation between the inlet member and the body member.

2. The pressure regulating valve according to claim 1, wherein
the inlet member is provided with an inlet-member leading end portion which contacts with the body member,
one of the inlet-member leading end portion and the body member is formed with a protrusion and the other is formed with a recess, and
the protrusion and the recess are fitted with each other.

3. The pressure regulating valve according to claim 1,
wherein the piston is provided with a rod-like portion having a leading end face which contacts with the valve element, and
the rod-like portion is formed to be thinner toward the leading end face.

4. The pressure regulating valve according to claim 1, wherein, in a direction perpendicular to an axial direction of the valve chamber, one of an outer peripheral surface of the valve element and an inner wall surface of the valve chamber has a circular or nearly circular cross-section and the other has an odd polygonal cross-section.

5. The pressure regulating valve according to claim 1, wherein the body member is made of material having lower pressure resistance than the inlet member.
